(19) United States
(12) Patent Application Publication
(10) Pub. No.: US 2026/0353504 A1
(43) Pub. Date: Nov. 5, 2026

(54) Group Common Signaling for Cell DTX/DRX Short Cycles

(71) Applicant: Apple Inc., Cupertino, CA (US)

(72) Inventors: Peng CHENG, Beijing (CN); Haijing HU, Los Gatos, CA (US); Ping-Heng KUO, London (GB); Ralf ROSSBACH, Munich (DE); Sigen YE, San Diego, CA (US)

(21) Appl. No.: 19/099,955

(22) PCT Filed: Aug. 4, 2023
(86) PCT No.: PCT/US2023/029526

§ 371 Date: Jan. 30, 2025

Related U.S. Application Data
(60) Provisional application No. 63/370,395, filed on Aug. 4, 2022.

(51) Int. Cl. H04W 76/28; H04W 8/22; H04W 72/231; H04W 74/0833

(52) U.S. Cl. CPC H04W 76/28; H04W 8/22; H04W 72/231; H04W 74/0833

(57) ABSTRACT

A user equipment is configured to decode a configuration for a first cell and second cell ON-OFF pattern for a serving cell. The second cell ON-OFF pattern comprises an ON duration during an OFF duration of the first cell ON-OFF pattern, decode, an activation for one or more ON durations of the second cell ON-OFF pattern. The UE assumes the ON duration of the second cell ON-OFF pattern is deactivated until the activation is received in a radio resource control message or in group common signaling and configure transceiver circuitry to perform an uplink transmission for cell reception or a downlink reception for cell transmission during the activated ON duration of the second cell ON-OFF pattern. The UL transmission or DL reception is performed only for traffic with an associated priority or delay requirement meeting a corresponding threshold or for random access traffic.

### BACKGROUND INFORMATION

A user equipment (UE) may establish a connection to at least one of a plurality of different networks or types of networks. For some types of network communications, the UE may be configured with a discontinuous reception (DRX) cycle or a discontinuous transmission (DTX) cycle to conserve power. The DRX/DTX cycle for the UE utilizes an active mode (ON duration) of data exchange processing and a sleep mode (OFF duration) of inactivity. A network cell (e.g., base station) can configure the DRX/DTX cycle for the UE and exchange communications with the UE, e.g., transmit downlink (DL) data/channels or reference signals and receive uplink (UL) transmissions, in dependence on the parameters of the DRX/DTX cycle(s) configured for the UE.

In 5G New Radio (NR), techniques can be implemented at the network cell (e.g., base station or gNB) to conserve power, including a cell DRX/DTX cycle where the gNB is configured with an active mode (ON duration) and a sleep mode (OFF duration) pattern. However, if the OFF duration of the cell DRX/DTX cycle is relatively long, the network may not be able to satisfy the quality of service (QOS) requirements of high priority traffic (e.g., ultra-reliable low latency communications (URLLC)).

### SUMMARY

Some exemplary embodiments are related to an apparatus of a user equipment (UE), the apparatus having processing circuitry configured to decode, from signaling received from a serving cell, a configuration for a first cell ON-OFF pattern and a second cell ON-OFF pattern for the serving cell, wherein the second cell ON-OFF pattern comprises at least one ON duration during an OFF duration of the first cell ON-OFF pattern, decode, from signaling received from a serving cell, an activation for one or more ON durations of the second cell ON-OFF pattern, wherein the UE assumes the at least one ON duration of the second cell ON-OFF pattern is deactivated until the activation is received in a radio resource control (RRC) message or in group common (GC) signaling and configure transceiver circuitry to perform an uplink (UL) transmission for cell reception or a downlink (DL) reception for cell transmission during the activated one or more ON durations of the second cell ON-OFF pattern, wherein the UL transmission or DL reception is performed only for traffic with an associated priority or delay requirement meeting a corresponding threshold or for random access (RACH) traffic.

Other exemplary embodiments are related to a processor configured to decode, from signaling received from a serving cell, a configuration for a first cell ON-OFF pattern and a second cell ON-OFF pattern for the serving cell, wherein the second cell ON-OFF pattern comprises at least one ON duration during an OFF duration of the first cell ON-OFF pattern, decode, from signaling received from a serving cell, an activation for one or more ON durations of the second cell ON-OFF pattern, wherein the UE assumes the at least one ON duration of the second cell ON-OFF pattern is deactivated until the activation is received in a radio resource control (RRC) message or in group common (GC) signaling and configure transceiver circuitry to perform an uplink (UL) transmission for cell reception or a downlink (DL) reception for cell transmission during the activated one or more ON durations of the second cell ON-OFF pattern, wherein the UL transmission or DL reception is performed only for traffic with an associated priority or delay requirement meeting a corresponding threshold or for random access (RACH) traffic.

Still further exemplary embodiments are related to an apparatus of a serving cell, the apparatus having processing circuitry configured to configure transceiver circuitry to transmit to one or more user equipment (UE) a configuration for a first cell ON-OFF pattern and a second cell ON-OFF pattern for the serving cell, wherein the second cell ON-OFF pattern comprises at least one ON duration during an OFF duration of the first cell ON-OFF pattern, configure transceiver circuitry to transmit, to at least a subset of the one or more UEs, an activation for one or more ON durations of the second cell ON-OFF pattern, wherein the one or more UEs assume the at least one ON duration of the second cell ON-OFF pattern is deactivated until the activation is received in a radio resource control (RRC) message or in group common (GC) signaling and configure transceiver circuitry to perform an uplink (UL) reception for UE transmission or a downlink (DL) transmission for UE reception during the activated one or more ON durations of the second cell ON-OFF pattern, wherein the UL reception or DL transmission is performed only for traffic with an associated priority or delay requirement meeting a corresponding threshold or for random access (RACH) traffic.

Additional exemplary embodiments are related to a processor configured to configure transceiver circuitry to transmit to one or more user equipment (UE) a configuration for a first cell ON-OFF pattern and a second cell ON-OFF pattern for the serving cell, wherein the second cell ON-OFF pattern comprises at least one ON duration during an OFF duration of the first cell ON-OFF pattern, configure transceiver circuitry to transmit, to at least a subset of the one or more UEs, an activation for one or more ON durations of the second cell ON-OFF pattern, wherein the one or more UEs assume the at least one ON duration of the second cell ON-OFF pattern is deactivated until the activation is received in a radio resource control (RRC) message or in group common (GC) signaling and configure transceiver circuitry to perform an uplink (UL) reception for UE transmission or a downlink (DL) transmission for UE reception during the activated one or more ON durations of the second cell ON-OFF pattern, wherein the UL reception or DL transmission is performed only for traffic with an associated priority or delay requirement meeting a corresponding threshold or for random access (RACH) traffic.

### BRIEF DESCRIPTION OF THE DRAWINGS

FIG. 1 shows a timing diagram for a long DTX/DRX cycle for a cell according to one example.

FIG. 2 shows a timing diagram for a plurality of short DTX/DRX cycles within a long DTX/DRX cycle for a cell according to various exemplary embodiments.

FIG. 3 shows a timing diagram for activation of short DTX/DRX cycles within a long DTX/DRX cycle for a cell according to various exemplary embodiments.

FIG. 4 shows a new MAC-CE format for activating or deactivating a short cell DTX/DRX cycle according to various exemplary embodiments.

FIG. 5 shows a timing diagram for activation of one or more short DTX cycles and one or more short DRX cycles within a long DTX/DRX cycle for a cell according to various exemplary embodiments.

FIG. 6 shows an exemplary method for signaling and configuration of cell DTX/DRX including a long cycle and one or more short cycles according to various exemplary embodiments.

FIG. 7 shows an exemplary network arrangement according to various exemplary embodiments.

FIG. 8 shows an exemplary base station according to various exemplary embodiments.

FIG. 9 shows an exemplary UE according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for configuring a discontinuous reception and/or discontinuous transmission (DRX/DTX) cycle for a network cell, e.g., gNB, where the gNB is configured with an active mode (ON duration) of data exchange with one or more user equipments (UEs) and a sleep mode (OFF duration) of inactivity. Specifically, the exemplary embodiments describe the configuration of one or more short DRX/DTX cycles for the cell during the OFF duration of a long DRX/DRX cycle for the cell so that some data/signaling transfers may take place during the long OFF duration. In some aspects, the cell may configure the long and short cell DRX/DTX cycles for a plurality of UEs in the cell and activate one or more short DRX/DTX cycles for a subset of the plurality of UEs, e.g., UEs with strict quality of service (QoS) requirements.

The exemplary embodiments describe signaling operations for configuring the long/short cell DRX/DTX cycles and activating one or more short cycles for a UE. The UE behaviors during the short cycles can include, e.g., the transmission of certain types of uplink (UL) traffics and/or the reception of DL traffics. In another aspect, the UE can request or indicate its preference for activating one or more short cycles by transmitting assistance information to the cell.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a 5G New Radio (NR) radio access network (RAN). However, reference to a 5G NR RAN is merely provided for illustrative purposes. The exemplary embodiments may be utilized with any network implementing cell DRX/DTX cycles similar to those described herein. Therefore, the 5G NR network as described herein may represent any type of network implementing similar DRX/DTX functionalities as the 5G NR network.

A UE DRX cycle can be configured for a UE according to existing methodologies to conserve UE power. The UE DRX cycle utilizes an active mode of data exchange processing and a sleep mode of inactivity. The UE may use the active mode of processing at defined intervals to perform scheduled operations such as performing measurements related to the network conditions, transmitting (e.g., requests, measurement reports, uplink data etc.), and receiving (e.g., control channel information, reference signals, synchronization signals, downlink data, etc.). The time period that the UE may be scheduled to receive may be referred to as the ON duration for the DRX cycle, or a DRX active time. The ON duration for a DRX cycle relates to a duration during which the UE may perform operations that enable the UE to receive data that may be transmitted to the UE such as but not limited to, control channel information, an uplink grant, a downlink grant, reference signals, synchronization signals, payload data etc.

During the DRX cycle, when an ON duration is not scheduled, the UE may have an opportunity to utilize the sleep mode of inactivity and conserve power. This period may be referred to as a DRX inactive time or OFF duration. However, reference to a DRX cycle is merely for illustrative purposes, and different networks may refer to similar concepts by a different name. The DRX cycle may have a predetermined duration N such as 100 ms, 50 ms, 40 ms, 20 ms, etc. For example, at a time 0, there may be a ON duration during which the active mode of processing is used. Subsequently, upon the conclusion of the ON duration, the UE has an opportunity to utilize the sleep mode of inactivity. Then at a time N, there may be another ON duration. Subsequently, the sleep mode is used until a time 2N. This process continues for the duration of the DRX cycle. Reference to the sleep mode of inactivity does not necessarily mean putting the processor, the transmitter, and the receiver of the UE to sleep, in hibernation, or in deactivation. For example, the processor (e.g., baseband and/or application) may continue to execute other applications or processes. The sleep mode relates to conserving power by discontinuing a continuous processing functionality relating to operations that enable the UE to receive data that may be transmitted to the UE and transmit data to the network. Further, reference to the DRX cycle being configured in ms units is merely for illustrative purposes, the exemplary aspects may utilize a DRX cycle that is based on subframes or any other suitable unit of time.

In Rel-18, techniques can be implemented on both the base station (e.g., gNB) and user equipment (UE) side to improve network energy consumption, e.g., base station transmission and reception power. These techniques may include more efficient dynamic and/or semi-static operations and finer granularity adaptation of transmissions and/or receptions and relate to the time, frequency, spatial, and/or power domains, with potential support/feedback from the UE, and potential UE assistance information. The techniques may further include information exchange/coordination over network interfaces. Additional/other techniques are not precluded. Idle/empty and low/medium load scenarios can be considered (the exact definition of such loads has not yet been defined), and different loads among carriers and neighbor cells are allowed.

In some examples, the power saving techniques can include gNB (cell) discontinuous transmission (DTX) and/or discontinuous reception (DRX) (ON-OFF pattern) and uplink (UL) wakeup signal (WUS). Similar to the UE DRX cycle described above, a cell DTX/DRX can utilize an ON duration wherein the gNB can transmit/receive signals/channels and an OFF duration wherein the gNB can disable some types of signal Rx/Tx processing and conserve power. Cell DTX/DRX can be applied to the UE in all RRC states (IDLE, INACTIVE, or CONNECTED) and covers both transmit (Tx) and receive (Rx) of the gNB.

As will be described in further detail below, according to the exemplary embodiments described herein, one type of cell DTX/DRX cycle may be referred to herein as a long cycle, while another type of cell DTX/DRX may be referred to herein as a short cycle. The long cell cycle can comprise a long ON duration and a long OFF duration that may be similar in length to the ON duration and OFF duration of a UE DRX cycle. In some examples, the long cell DRX/DTX ON duration can substantially or partly overlap with the UE DRX ON duration.

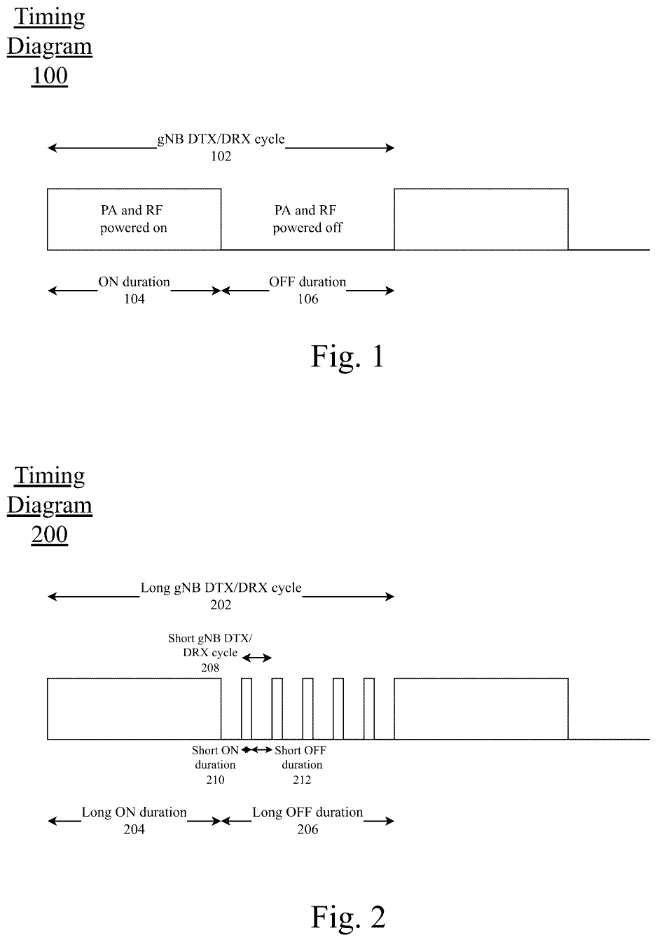

FIG. 1 shows a timing diagram 100 for a long DTX/DRX cycle 102 for a cell, e.g., a gNB, according to one example. Each DTX/DRX cycle 102 comprises an ON duration 104, during which the power amplifier (PA) and radiofrequency (RF) front end of the gNB are powered on, and an OFF duration 106 when the PA and RF are turned off and the gNB can conserve power. The duration of the DTX/DRX cycle 102, and the length of the ON duration 104 relative to the OFF duration 106, can vary. When the gNB DTX/DRX cycle 102 is long, the quality of service (Qos) requirements of high priority traffic may not be satisfied if these traffics arrive at the UE during the OFF duration 106 of the cycle 102 (when the gNB is sleeping).

According to various exemplary embodiments described herein, the gNB can configure one or more short DTX/DRX cycles in between the long DTX/DRX cycle for the cell. During the short ON durations of the short DTX/DRX cycles, some UL/DL transmissions for high priority traffic (e.g., URLLC traffic) can be allowed. The short DRX/DTX cycles can be further classified into multiple types based on, e.g., transmission direction (DL only, UL only, DL+UL), gNB sleep modes, types of UEs who can access, priority of data radio bearers (DRBs) or logical channels (LCHs) that can transmit, etc., to be described in greater detail below.

A major contributor to gNB power consumption includes random access (RACH) messages, scheduling requests (SR) and configured grant physical uplink shared channel (CG-PUSCH) receptions, for which the gNB needs to perform blind detection. Thus, in some embodiments, these types of communications can be allowed during the short ON durations so that, for example, a UE having strict QoS requirements can transmit on the UL during the long ON duration of the cell, but the cell is not required to perform blind detection for the entirety of this long ON duration. In some embodiments, the gNB can activate only a subset of the cell short cycles configured for the UE. Additionally, the gNB can activate the one or more cell short cycles for only a subset of the UEs in the cell, e.g., one or more UE groups, based on certain grouping criteria to be explained below.

FIG. 2 shows a timing diagram 200 for a plurality of short DTX/DRX cycles 208 within a long DTX/DRX cycle 202 for a cell, e.g., a gNB, according to various exemplary embodiments. Similar to the timing diagram 100 of FIG. 1, each long DTX/DRX cycle 202 comprises an ON duration 204 (long ON duration) and an OFF duration 206 (long OFF duration). In the present example, during the OFF duration 206 of the long DTX/DRX cycle 202, five short DTX/DRX cycles 208 are configured, each comprising a short ON duration 210 and a short OFF duration 212. Although five short cycles 208 are shown in FIG. 2, a greater or lesser number of short cycles 208 can be configured during the ON duration 204 of the long cycle 202. Similar to the long cycle 202, the duration of the short cycle 208, and the length of the short ON duration 210 relative to the short OFF duration 212, can vary. During the long DTX/DRX ON duration 202, the gNB can indicate to the UE whether to activate one or more of the configured short DTX/DRX cycles 208, as will be explained in further detail below.

According to various exemplary embodiments described herein, a UE can receive a configuration for a long cell DTX/DRX cycle and a configuration for a short cell DTX/DRX cycle comprising one or more ON durations during the long cycle OFF duration. The configurations for the long and short cycles can be received via, e.g., a system information block (SIB) or dedicated RRC signaling. In some embodiments, multiple short cycles can be configured during a single long cycle (e.g., the short cycles repeat for a configured duration), and one or more of the configured short cycles can be activated or deactivated via an indication received in, e.g., a group common (GC) DCI, a GC MAC-CE, and/or an RRC message, to be explained in greater detail below. In some embodiments, both configuration and activation parameters can be received via SIB or dedicated RRC signaling. In other aspects of these exemplary embodiments, UE behavior during the short DRX/DTX cycle and UE assistance information are described.

In one option, the long and short cell DTX/DRX cycles can be configured in SIB. The configurations provided in SIB can include: a cell-specific long DTX/DRX cycle (e.g., ON-OFF pattern) ; a cell-specific short DRX cycle (e.g., ON-OFF pattern) for gNB reception (Rx) during the long DRX/DTX OFF duration; and/or a cell-specific short DTX cycle (e.g., on ON-OFF pattern) for gNB transmission (Tx) during the long DRX/DTX OFF duration. In another option, both the long and short cycles can be configured in dedicated RRC signaling. In still another option, the long cell cycle can be configured in SIB and the short cell cycle(s) can be configured in dedicated RRC signaling.

Regarding the long cycle, the gNB can choose, based on gNB implementation, whether to align the cell DTX/DRX ON-OFF pattern with the UE DRX pattern and/or the core network (CN) or radio access network (RAN) paging cycle(s). In some scenarios, it may be beneficial to align these cycles, e.g., to align the beginning of the ON durations for the various cycles. In other scenarios, it may not be necessary to align these cycles. During the long DRX/DTX OFF duration, and in the absence of any short DRX/DTX configurations, the gNB will turn off its power amplifier (PA) and RF front end (e.g., no Tx or Rx) and the UE will not transmit for gNB reception during the DRX OFF duration and will not expect to receive gNB transmissions during the DTX OFF duration.

If the short DRX cycle for gNB Rx is configured and activated for one or more UEs, the gNB will turn on its PA and RF for Rx during the short DRX ON durations. During these short cell DRX ON durations the UE can be allowed to transmit some traffics, e.g., high priority traffic, on the UL, to be described below. If the short cycle for gNB Tx is configured, the gNB will turn on its PA and RF for Tx during the short ON durations. During these short cell DTX ON durations, the UE may expect to receive some traffics, e.g., high priority traffic, on the DL, to be described below.

In some embodiments, the short ON-OFF patterns configured in SIB/RRC can be assumed to be in a deactivated state until activated by the gNB via activation/deactivation signaling, to be described below. In other embodiments, the short ON-OFF patterns configured in SIB/RRC can be assumed to be in an activated state until deactivated by the gNB. In this scenario, the UE can follow the short ON-OFF pattern once configured and need not receive any activation signaling (e.g., GC signaling). In either scenario, the activation/deactivation signaling can override the activation/deactivation indication in the SIB/RRC configuration.

The short cycles may be activated only for some UEs in a cell, e.g., one or more groups of UEs. The membership in the UE groups can be determined based on network implementation. In one example, the UEs may be grouped by QoS. In another example, the UEs may be grouped by capability. The cell may determine only two groups, e.g., UEs with URLLC capabilities and UEs without such capabilities. In another example, the UEs may be grouped by priority of service (e.g., “golden members” or not), or by priority of DRB or logical channel. In other embodiments, the number of groups can be larger and depend on other UE and/or network considerations. In still other embodiments, some UEs can belong to multiple groups.

The UE grouping(s) can be configured in RRC or can be configured by the access and mobility management function (AMF) of the core network (CN), for example, in a manner similar to group paging specified in Rel-17 UE power saving. The AMF can include a configuration of several UE groups and their group members in the NAS message towards the UE.

In one embodiment, the gNB can associate each group of UEs with a code point and provide the UEs in the cell, e.g., via a UE-dedicated RRC message, with a mapping of each code point to a UE group index and an identification of members in the UE group so that the UE can determine to which group(s) the UE belongs. In some embodiments, the UE-dedicated RRC message can further include, for each code point, an indication of which short DTX/DRX cycles are activated in an upcoming long DTX/DRX OFF duration. For example, the indication can comprise an activation for all the short DTX/DRX cycles falling within the long OFF duration, a pattern for activation/deactivation (alternating or otherwise), a duration for the indicated activation pattern, etc. However, any activation/deactivation indication received in this RRC message could, in some embodiments, be overridden by group common (GC) activation/deactivation signaling or a further UE-dedicated RRC message that indicates the code point associated with a particular UE group to which the UE belongs and a different activation/deactivation pattern.

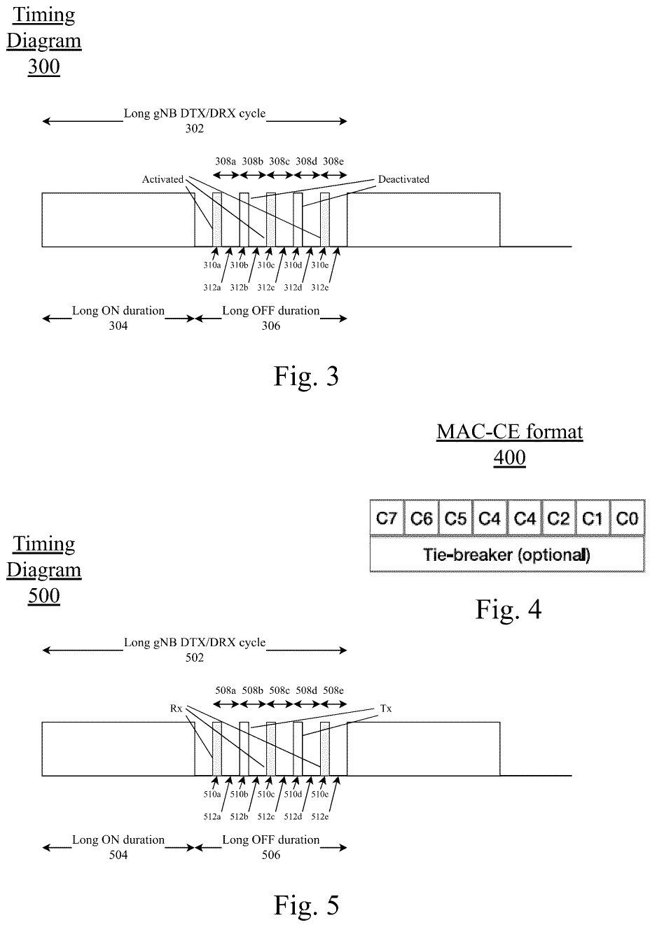

FIG. 3 shows a timing diagram 300 for activation of short DTX/DRX cycles 308 within a long DTX/DRX cycle 302 for a cell, e.g., a gNB, according to various exemplary embodiments. Similar to the timing diagram 200 of FIG. 2, each long DTX/DRX cycle 302 comprises an ON duration 304 (long ON duration) and an OFF duration 306 (long OFF duration) and, during the OFF duration 306 of the long DTX/DRX cycle 302, five short DTX/DRX cycles 308 are configured, each comprising a short ON duration 310 and a short OFF duration 312.

The five short DTX/DRX cycles 308 can be configured in SIB or RRC, as described above. The short cycles 308 can be configured for the UE for a duration including, e.g., the ON duration 304 of the long cycle 302. In this example, the activation configuration/signaling received by the UE indicates that the first short cycle 308a, the third short cycle 308c, and the fifth short cycle 308e are activated while the second short cycle 308b and the fourth short cycle 308d remain deactivated.

The short cycles can be activated by the gNB depending on, for example, a gNB estimation of UL loading across one or more UEs in the cell. Different short DTX/DRX cycles may be activated for different UE groups and/or different UEs/DRBs associated with a specific QoS. The short cycles can be activated for a single long cycle or for multiple long cycles based on an indicated duration or UE specification.

The short DTX/DRX cycle activation/deactivation can be signaled in various ways including: a new group-common DCI (GC-DCI); a new MAC-CE sent with PDSCH associated to a group common RNTI; a combination of DCI and MAC-CE; or an RRC message. The new MAC-CE can comprise a format comprising a plurality of one-bit fields, each field corresponding to a different one of the upcoming configured short cycles, wherein the value of the field indicates whether the corresponding short cycle is activated or deactivated.

FIG. 4 shows a new MAC-CE format 400 for activating or deactivating a short cell DTX/DRX cycle according to various exemplary embodiments. In this example, the MAC-CE 400 comprises 8 fields, C0-C7, wherein Ci=1 indicates the cycle i is activated and Ci=0 indicates the cycle i is deactivated. The MAC-CE 400 can optionally include a tie-breaker field to separate the new MAC-CE 400 from other MAC-CEs.

The activation signaling can indicate to a UE to activate the indicated short DRX/DTX cycles in one or multiple upcoming long DTX/DRX OFF durations. Any UEs in the cell that do not receive the activation signaling can follow the short DTX/DRX configuration from SIB/RRC, as described above.

In some aspects, a UE can be configured with a plurality of short DTX/DRX cycles within a single long cycle OFF duration wherein one or more of the short cycles are activated for gNB Rx, one or more short cycles are activated for gNB Tx, and/or one or more short cycles are activated for both Rx and Tx.

FIG. 5 shows a timing diagram 500 for activation of one or more short DTX cycles 508 and one or more short DRX cycles within a long DTX/DRX cycle 502 for a cell, e.g., a gNB, according to various exemplary embodiments. Similar to the timing diagram 400 of FIG. 4, each long DTX/DRX cycle 502 comprises an ON duration 504 (long ON duration) and an OFF duration 506 (long OFF duration) and, during the OFF duration 506 of the long DTX/DRX cycle 502, five short DTX/DRX cycles 508 are configured, each comprising a short ON duration 510 and a short OFF duration 512.

The five short DTX/DRX cycles 508 can be configured in SIB or RRC, as described above. In this example, the activation configuration/signaling received by the UE indicates that the first short cycle 508a, the third short cycle 508c, and the fifth short cycle 508e are activated for gNB Rx while the second short cycle 508b and the fourth short cycle 508d are activated for gNB Tx.

In another aspect of these exemplary embodiments, various types of UE behaviors can be allowed during the activated short cell DRX/DTX cycles.

When a short cell DRX cycle is activated for gNB Rx, the UE can be allowed to transmit on the UL during the short DRX cycle. Certain UL transmissions can be allowed if, for example, the logical channel (LCH) priority for the UL transmission is greater than a configured/predetermined threshold; or if the packet delay budget (PDB) for the UL transmission is less than a configured/predetermined threshold.

In one example, the UE can transmit a scheduling request (SR) during the short DRX cycle if the LCH priority>configured threshold or PDB<configured threshold. In another example, the UE can transmit a buffer status report (BSR) if triggered by arriving traffic in the logical cell group (LCG) whose minimum LCH priority>configured threshold or PDB<configured threshold. In still another example, the UE can transmit UL scheduled transmissions or retransmissions whose LCH priority>configured threshold or PDB<configured threshold. In still another example, the UE can transmit configured grant (CG) if the LCH priority of data in the buffer>configured threshold or PDB<configured threshold. In still another example, the UE can transmit RACH messages.

In some embodiments, during the activated short ON-OFF cycles for gNB Rx, only UEs with high priority traffic (LCH priority>threshold) will wake up while UEs with lower priority traffic will not transmit during the short cycles, even if the short cycles are activated.

When a short cell DTX cycle is activated for gNB Tx, the UE can be allowed to receive on the DL during the short DTX cycle. From the UE perspective, any type of DL transmission can be received, however, the gNB may transmit only high priority traffic meeting priority or delay requirements similar to those discussed above. For these activated short ON-OFF cycles for gNB Tx, the UEs that receive the corresponding activation signaling will wake up for reception during these cycles.

In still another aspect of these exemplary embodiments, during a long cell DRX/DTX ON duration, the UE can send assistance information to the gNB indicating its preference to activate one or more short DRX/DTX cycles in the upcoming long cell DRX/DTX OFF duration, for example, if the UE anticipates upcoming high priority traffic. The UE assistance information can be sent, e.g., via a UE assistance IE (UAI) or via UL wakeup signal (WUS) signaling.

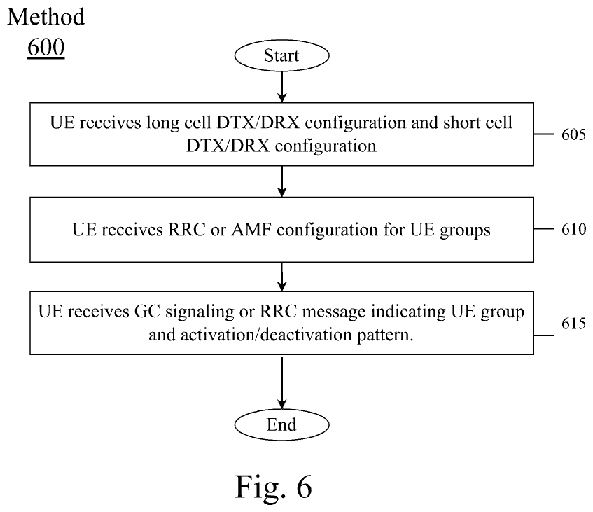

FIG. 6 shows an exemplary method 600 for signaling and configuration of cell DTX/DRX including a long cycle and one or more short cycles according to various exemplary embodiments.

In 605, the UE receives a long cell DTX/DRX configuration (ON-OFF pattern) and a short cell DTX and/or DRX configuration (ON-OFF pattern) from a serving cell. In some embodiments, the short cycle configuration can include a duration. The cell DTX/DRX configuration can be received from the serving cell via SIB, RRC, or a combination of SIB and RRC.

As described above, the short ON-OFF patterns configured in SIB/RRC can be assumed to be in a deactivated state or an activated state until activated/deactivated by the gNB via activation/deactivation signaling. If the short cycles are assumed to be activated, the UE can follow the short ON-OFF pattern once configured and need not receive any activation signaling (e.g., GC signaling). In either scenario, the activation/deactivation signaling can override the activation/deactivation indication in the SIB/RRC configuration.

In 610, the UE receives an RRC configuration from the serving cell (or AMF configuration) comprising a UE group configuration. In some embodiments, the RRC configuration includes an index for multiple GC signaling code points and a mapping of each code point to a UE group index and an identification of members in the UE group. From this information, the UE can determine to which group the UE belongs. The RRC configuration may also indicate which short DRX/DTX cycles are activated in one or more upcoming long DRX/DTX OFF durations. The RRC configuration may also indicate a duration for the short cycle activation, wherein each duration can be mapped to a code point in GC signaling. In other embodiments, the UE group configuration is received from the AMF.

The UE can follow the activation/deactivation pattern indicated in the RRC configuration (if included) until a (further) activation/deactivation signaling is received from the network. In some embodiments, the UE can indicate its preference for, or request, the gNB to activate one or more short cycles in an upcoming one or more long duration. The UE can indicate these preferences in UE assistance information sent via a UE assistance IE (UAI) or UL wakeup signaling (WUS). The UE can determine to send the UE assistance information if, for example, the UE has upcoming high priority traffic.

In 615, the UE receives a message, e.g., GC signaling or RRC message (indicating the code point of the UE group to which the UE belongs), indicating the UE to activate/deactivate one or more upcoming short cycles. The message can comprise a new GC DCI, a new GC MAC-CE, or RRC. The message can also indicate a duration for the (temporary) activation/deactivation pattern.

If a short DRX cycle is activated for cell Rx, the UE can be allowed to transmit certain SR, BSR, UL scheduled transmissions or retransmissions, or configured grants if certain priority or timing thresholds for the transmissions are met. The UE can also be allowed to transmit RACH messages. In some embodiments, during activated short ON-OFF cycles for gNB Rx, only UEs with high priority traffic will wake up while UEs with lower priority traffic will not transmit during the activated short cycles. If a short DTX cycle is activated for cell Tx, the UE can be allowed to receive on the DL during the short DTX cycle.

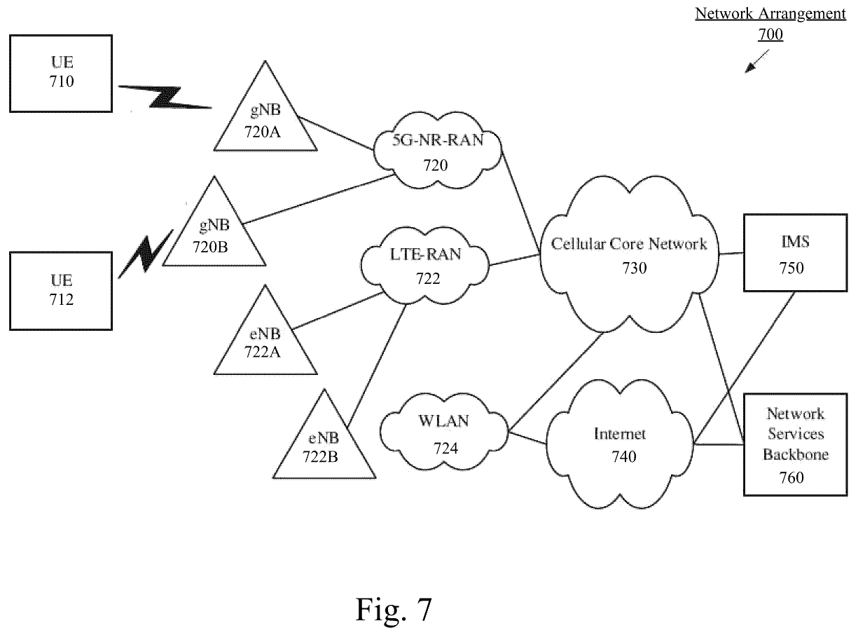

FIG. 7 shows an exemplary network arrangement 700 according to various exemplary embodiments. The exemplary network arrangement 700 includes UEs 710, 712. Those skilled in the art will understand that the UEs 710, 712 may be any type of electronic component that is configured to communicate via a network, e.g., mobile phones, tablet computers, desktop computers, smartphones, phablets, embedded devices, wearables (e.g., HMD, AR glasses, etc.), Internet of Things (IOT) devices, etc. It should also be understood that an actual network arrangement may include any number of UEs being used by any number of users. Thus, the example of two UES 710, 712 is merely provided for illustrative purposes.

The UEs 710, 712 may communicate directly with one or more networks. In the example of the network configuration 700, the networks with which the UEs 710, 712 may wirelessly communicate are a 5G NR radio access network (5G NR-RAN) 720, an LTE radio access network (LTE-RAN) 722 and a wireless local access network (WLAN) 724. However, the UEs 710, 712 may also communicate with other types of networks and the UEs 710, 712 may also communicate with networks over a wired connection. Therefore, the UEs 710, 712 may include a 5G NR chipset to communicate UE 710 with the 5G NR-RAN 720, an LTE chipset to communicate with the LTE-RAN 722 and an ISM chipset to communicate with the WLAN 724.

The 5G NR-RAN 720 and the LTE-RAN 722 may be portions of cellular networks that may be deployed by a network carrier (e.g., Verizon, AT&T, T-Mobile, etc.). These networks 720, 722 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 724 may include any type of wireless local area network (WiFi, Hot Spot, IEEE 802.11x networks, etc.).

The UEs 710, 712 may connect to the 5G NR-RAN via the gNB 720A or the gNB 720B. Reference to two gNBs 720A, 720B is merely for illustrative purposes. The exemplary embodiments may apply to any appropriate number of gNBs. The UEs 710, 712 may also connect to the LTE-RAN 722 via the eNBs 722A, 722B. Those skilled in the art will understand that any association procedure may be performed for the UEs 710, 712 to connect to the 5G NR-RAN 720 and the LTE-RAN 722. For example, as discussed above, the 5G NR-RAN 720 and the LTE-RAN 722 may be associated with a particular cellular provider where the UEs 710, 712 and/or the user thereof has a contract and credential information (e.g., stored on a SIM card). Upon detecting the presence of the 5G NR-RAN 720, the UEs 710, 712 may transmit the corresponding credential information to associate with the 5G NR-RAN 720. More specifically, the UEs 710, 712 may associate with a specific base station (e.g., the gNB 720A of the 5G NR-RAN 720, the eNB 722A of the LTE-RAN 722).

In addition to the networks 720, 722 and 724 the network arrangement 700 also includes a cellular core network 730, the Internet 740, an IP Multimedia Subsystem (IMS) 750, and a network services backbone 760. The cellular core network 730 may be considered to be the interconnected set of components that manages the operation and traffic of the cellular network. The cellular core network 730 also manages the traffic that flows between the cellular network and the Internet 740. The IMS 750 may be generally described as an architecture for delivering multimedia services to the UE 710 using the IP protocol. The IMS 750 may communicate with the cellular core network 730 and the Internet 740 to provide the multimedia services to the UE 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the UEs 710, 712 in communication with the various networks.

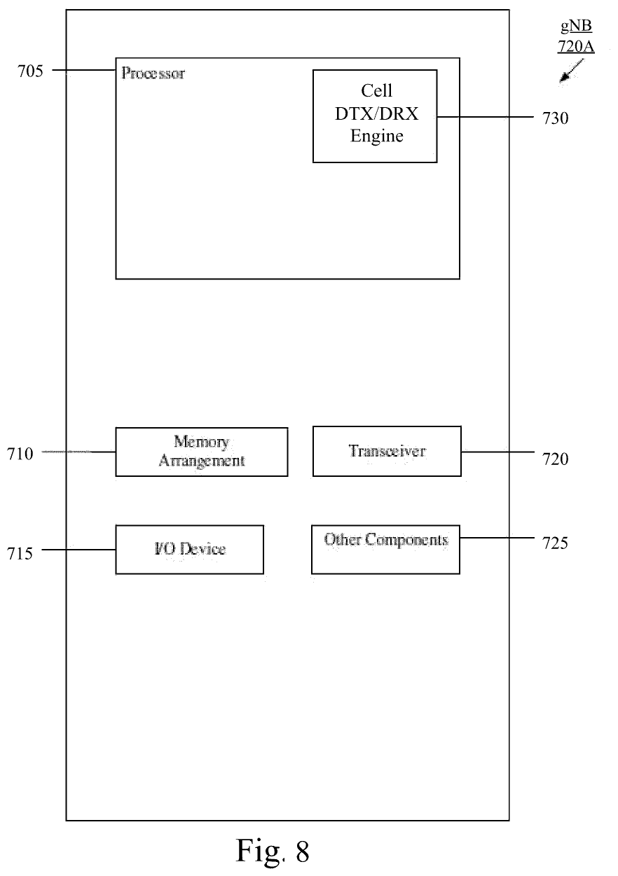

FIG. 8 shows an exemplary base station 720A according to various exemplary embodiments. The base station 720A will be described with regard to the network arrangement 700 of FIG. 7. The base station 720A may represent any access node through which the UE 710 may establish a connection and manage network operations. The base station 720A may also represent the gNB 720B described above with respect to FIG. 7.

The base station 720A may include a processor 805, a memory arrangement 810, an input/output (I/O) device 815, a transceiver 820, and other components 825. The other components 825 may include, for example, a battery, a data acquisition device, ports to electrically connect the base station 720A to other electronic devices, etc.

The processor 805 may be configured to execute a plurality of engines of the base station 720A. For example, the engines may include a cell DTX/DRX engine 830 for performing operations related to configuring and activating one or more short DTX/DRX cycles for a UE, as described above.

The above noted engine 830 being an application (e.g., a program) executed by the processor 805 is only exemplary. The functionality associated with the engine 830 may also be represented as a separate incorporated component of the base station 720A or may be a modular component coupled to the base station 720A, e.g., an integrated circuit with or without firmware. For example, the integrated circuit may include input circuitry to receive signals and processing circuitry to process the signals and other information. In addition, in some base stations, the functionality described for the processor 805 is split among a plurality of processors (e.g., a baseband processor, an applications processor, etc.) . The exemplary embodiments may be implemented in any of these or other configurations of a base station.

The memory 810 may be a hardware component configured to store data related to operations performed by the base station 720A. The I/O device 815 may be a hardware component or ports that enable a user to interact with the base station 720A.

The transceiver 820 may be a hardware component configured to exchange data with the UE 710 and any other UE in the system 700. The transceiver 820 may operate on a variety of different frequencies or channels (e.g., set of consecutive frequencies). Therefore, the transceiver 820 may include one or more components (e.g., radios) to enable the data exchange with the various networks and UEs. The transceiver 820 includes circuitry configured to transmit and/or receive signals (e.g., control signals, data signals). Such signals may be encoded with information implementing any one of the methods described herein. The processor 805 may be operably coupled to the transceiver 820 and configured to receive from and/or transmit signals to the transceiver 820. The processor 805 may be configured to encode and/or decode signals (e.g., signaling from a UE) for implementing any one of the methods described herein.

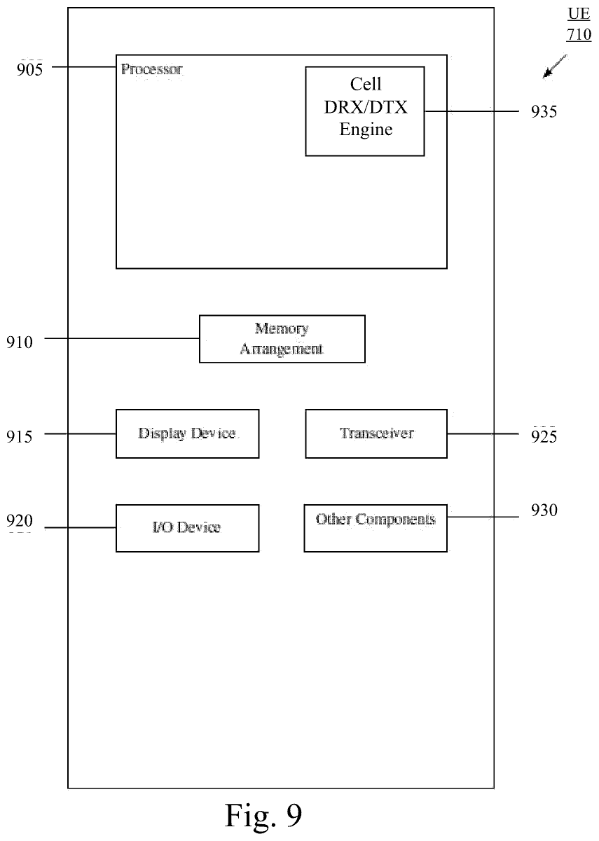

FIG. 9 shows an exemplary UE 710 according to various exemplary embodiments. The UE 710 will be described with regard to the network arrangement 700 of FIG. 7. The UE 710 may also represent UE 712. The UE 710 may include a processor 905, a memory arrangement 910, a display device 915, an input/output (I/O) device 920, a transceiver 925 and other components 930. The other components 930 may include, for example, an audio input device, an audio output device, a power supply, a data acquisition device, ports to electrically connect the UE 710 to other electronic devices, etc.

The processor 905 may be configured to execute a plurality of engines of the UE 710. For example, the engines may include a cell DTX/DRX engine 935 for performing various operations related to configuration and activation of one or more short cell DTX/DRX cycles, as described above.

The above referenced engine 935 being an application (e.g., a program) executed by the processor 905 is provided merely for illustrative purposes. The functionality associated with the engine 935 may also be represented as a separate incorporated component of the UE 710 or may be a modular component coupled to the UE 710, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 905 is split among two or more processors such as a baseband processor and an applications processor. The exemplary embodiments may be implemented in any of these or other configurations of a UE.

The memory arrangement 910 may be a hardware component configured to store data related to operations performed by the UE 710. The display device 915 may be a hardware component configured to show data to a user while the I/O device 920 may be a hardware component that enables the user to enter inputs. The display device 915 and the I/O device 920 may be separate components or integrated together such as a touchscreen.

The transceiver 925 may be a hardware component configured to establish a connection with the 5G NR-RAN 720 and/or any other appropriate type of network. Accordingly, the transceiver 925 may operate on a variety of different frequencies or channels (e.g., set of consecutive frequencies). The transceiver 925 includes circuitry configured to transmit and/or receive signals (e.g., control signals, data signals).

Such signals may be encoded with information implementing any one of the methods described herein. The processor 905 may be operably coupled to the transceiver 925 and configured to receive from and/or transmit signals to the transceiver 925. The processor 905 may be configured to encode and/or decode signals (e.g., signaling from a base station of a network) for implementing any one of the methods described herein.

### EXAMPLES

In a first example, a method is performed by a user equipment (UE), comprising receiving a configuration for a first cell ON-OFF pattern and a second cell ON-OFF pattern for a serving cell, wherein the second cell ON-OFF pattern comprises at least one ON duration during an OFF duration of the first cell ON-OFF pattern, receiving an activation for one or more ON durations of the second cell ON-OFF pattern, wherein the UE assumes the at least one ON duration of the second cell ON-OFF pattern is deactivated until the activation is received in a radio resource control (RRC) message or in group common (GC) signaling and performing an uplink (UL) transmission for cell reception or a downlink (DL) reception for cell transmission during the activated one or more ON durations of the second cell ON-OFF pattern, wherein the UL transmission or DL reception is performed only for traffic with an associated priority or delay requirement meeting a corresponding threshold or for random access (RACH) traffic.

In a second example, the method of the first example, further comprising receiving a configuration for a plurality of UE groups and determining to which one of the plurality of UE groups the UE belongs.

In a third example, the method of the second example, wherein the configuration for the plurality of UE groups includes an index for multiple GC signaling code points and a mapping of each code point to a UE group index and an identification of members of the UE group.

In a fourth example, the method of the third example, wherein the configuration for the plurality of UE groups is received via RRC or an access and mobility management function (AMF).

In a fifth example, the method of the third example, wherein the plurality of UE groups are determined according to quality of service (Qos) requirements or capabilities.

In a sixth example, the method of the third example, wherein the activation comprises an indication of the UE group to which the UE belongs and identifies the activated one or more ON durations of the second cell ON-OFF pattern.

In a seventh example, the method of the first example, wherein the activation further comprises a duration for an activation pattern.

In an eighth example, the method of the first example, wherein the activation is received via a group common (GC) downlink control information (DCI, a GC medium access control (MAC) control element (MAC-CE), a combination of the GC DCI and the GC MAC-CE, or a radio resource control (RRC) message.

In a ninth example, a processor configured to perform any of the methods of the first through eighth examples.

In an tenth example, a user equipment (UE), comprising a transceiver configured to communicate with a serving cell and a processor communicatively coupled to the transceiver and configured to perform any of the methods of the first through eighth examples.

In an eleventh example, a method performed by a serving cell, comprising transmitting to one or more user equipment (UE) a configuration for a first cell ON-OFF pattern and a second cell ON-OFF pattern for the serving cell, wherein the second cell ON-OFF pattern comprises at least one ON duration during an OFF duration of the first cell ON-OFF pattern, transmitting, to at least a subset of the one or more UEs, an activation for one or more ON durations of the second cell ON-OFF pattern, wherein the one or more UEs assume the at least one ON duration of the second cell ON-OFF pattern is deactivated until the activation is received in a radio resource control (RRC) message or in group common (GC) signaling and performing an uplink (UL) reception for UE transmission or a downlink (DL) transmission for UE reception during the activated one or more ON durations of the second cell ON-OFF pattern, wherein the UL reception or DL transmission is performed only for traffic with an associated priority or delay requirement meeting a corresponding threshold or for random access (RACH) traffic.

In a twelfth example, the method of the eleventh example, further comprising transmitting a configuration for a plurality of UE groups, wherein each UE receiving the configuration for the plurality of UE groups determines to which one of the plurality of UE groups the respective UE belongs.

In a thirteenth example, the method of the twelfth example, wherein the configuration for the plurality of UE groups includes an index for multiple GC signaling code points and a mapping of each code point to a UE group index and an identification of members of the UE group.

In a fourteenth example, the method of the thirteenth example, wherein the configuration for the plurality of UE groups is transmitted via RRC or an access and mobility management function (AMF).

In a fifteenth example, the method of the thirteenth example, wherein the plurality of UE groups are determined according to quality of service (Qos) requirements or capabilities.

In a sixteenth example, the method of the thirteenth example, wherein the activation comprises an indication of the UE group to which the subset of UEs belong and identifies the activated one or more ON durations of the second cell ON-OFF pattern.

In a seventeenth example, the method of the sixteenth example, wherein the activation further comprises a duration for an activation pattern.

In an eighteenth example, the method of the eleventh example, wherein the activation is transmitted via a group common (GC) downlink control information (DCI, a GC medium access control (MAC) control element (MAC-CE), a combination of the GC DCI and the GC MAC-CE, or a radio resource control (RRC) message.

In a nineteenth example, a processor configured to perform any of the methods of the eleventh through eighteenth examples.

In a twentieth example, a base station comprising a transceiver configured to communicate with a user equipment (UE) and a processor communicatively coupled to the transceiver and configured to perform any of the methods of the eleventh through eighteenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. An apparatus of a user equipment (UE), the apparatus comprising processing circuitry configured to:
decode, from signaling received from a serving cell, a configuration for a first cell ON-OFF pattern and a second cell ON-OFF pattern for the serving cell, wherein the second cell ON-OFF pattern comprises at least one ON duration during an OFF duration of the first cell ON-OFF pattern;
decode, from signaling received from a serving cell, an activation for one or more ON durations of the second cell ON-OFF pattern, wherein the UE assumes the at least one ON duration of the second cell ON-OFF pattern is deactivated until the activation is received in a radio resource control (RRC) message or in group common (GC) signaling; and
configure transceiver circuitry to perform an uplink (UL) transmission for cell reception or a downlink (DL) reception for cell transmission during the activated one or more ON durations of the second cell ON-OFF pattern, wherein the UL transmission or DL reception is performed only for traffic with an associated priority or delay requirement meeting a corresponding threshold or for random access (RACH) traffic.

2. The apparatus of claim 1, wherein the processing circuitry is further configured to:
decode, from signaling received from the serving cell, a configuration for a plurality of UE groups; and
determine to which one of the plurality of UE groups the UE belongs.

3. The apparatus of claim 2, wherein the configuration for the plurality of UE groups includes an index for multiple GC signaling code points and a mapping of each code point to a UE group index and an identification of members of the UE group.

4. The apparatus of claim 3, wherein the configuration for the plurality of UE groups is received via RRC or an access and mobility management function (AMF).

5. The apparatus of claim 3, wherein the plurality of UE groups are determined according to quality of service (Qos) requirements or capabilities.

6. The apparatus of claim 3, wherein the activation comprises an indication of the UE group to which the UE belongs and identifies the activated one or more ON durations of the second cell ON-OFF pattern.

7. The apparatus of claim 6, wherein the activation further comprises a duration for an activation pattern.

8. The apparatus of claim 1, wherein the activation is received via a group common (GC) downlink control information (DCI, a GC medium access control (MAC) control element (MAC-CE), a combination of the GC DCI and the GC MAC-CE, or a radio resource control (RRC) message.

9. A processor configured to:
decode, from signaling received from a serving cell, a configuration for a first cell ON-OFF pattern and a second cell ON-OFF pattern for the serving cell, wherein the second cell ON-OFF pattern comprises at least one ON duration during an OFF duration of the first cell ON-OFF pattern;
decode, from signaling received from a serving cell, an activation for one or more ON durations of the second cell ON-OFF pattern, wherein the UE assumes the at least one ON duration of the second cell ON-OFF pattern is deactivated until the activation is received in a radio resource control (RRC) message or in group common (GC) signaling; and
configure transceiver circuitry to perform an uplink (UL) transmission for cell reception or a downlink (DL) reception for cell transmission during the activated one or more ON durations of the second cell ON-OFF pattern, wherein the UL transmission or DL reception is performed only for traffic with an associated priority or delay requirement meeting a corresponding threshold or for random access (RACH) traffic.

10. The processor of claim 9, further configured to:
decode, from signaling received from the serving cell, a configuration for a plurality of UE groups; and
determine to which one of the plurality of UE groups the UE belongs.

11. The processor of claim 10, wherein the configuration for the plurality of UE groups includes an index for multiple GC signaling code points and a mapping of each code point to a UE group index and an identification of members of the UE group.

12. The processor of claim 11, wherein the configuration for the plurality of UE groups is received via RRC or an access and mobility management function (AMF).

13. An apparatus of a serving cell, the apparatus comprising processing circuitry configured to:
configure transceiver circuitry to transmit to one or more user equipment (UE) a configuration for a first cell ON-OFF pattern and a second cell ON-OFF pattern for the serving cell, wherein the second cell ON-OFF pattern comprises at least one ON duration during an OFF duration of the first cell ON-OFF pattern;
configure transceiver circuitry to transmit, to at least a subset of the one or more UEs, an activation for one or more ON durations of the second cell ON-OFF pattern, wherein the one or more UEs assume the at least one ON duration of the second cell ON-OFF pattern is deactivated until the activation is received in a radio resource control (RRC) message or in group common (GC) signaling; and
configure transceiver circuitry to perform an uplink (UL) reception for UE transmission or a downlink (DL) transmission for UE reception during the activated one or more ON durations of the second cell ON-OFF pattern, wherein the UL reception or DL transmission is performed only for traffic with an associated priority or delay requirement meeting a corresponding threshold or for random access (RACH) traffic.

14. The apparatus of claim 13, wherein the processing circuitry is further configured to:
configure transceiver circuitry to transmit a configuration for a plurality of UE groups, wherein each UE receiving the configuration for the plurality of UE groups determines to which one of the plurality of UE groups the respective UE belongs.

15. The apparatus of claim 14, wherein the configuration for the plurality of UE groups includes an index for multiple GC signaling code points and a mapping of each code point to a UE group index and an identification of members of the UE group.

16. The apparatus of claim 15, wherein the configuration for the plurality of UE groups is transmitted via RRC or an access and mobility management function (AMF).

17. The apparatus of claim 15, wherein the plurality of UE groups are determined according to quality of service (Qos) requirements or capabilities.

18. The apparatus of claim 15, wherein the activation comprises an indication of the UE group to which the subset of UEs belong and identifies the activated one or more ON durations of the second cell ON-OFF pattern.

19. The apparatus of claim 18, wherein the activation further comprises a duration for an activation pattern.

20. The apparatus of claim 13, wherein the activation is transmitted via a group common (GC) downlink control information (DCI, a GC medium access control (MAC) control element (MAC-CE), a combination of the GC DCI and the GC MAC-CE, or a radio resource control (RRC) message.
